(19) United States
(12) Patent Application Publication
(10) Pub. No.: US 2015/0253904 A1
(43) Pub. Date: Sep. 10, 2015

(54) TOUCH SENSITIVE HOUSING AND METHOD OF MAKING THE SAME

(71) Applicant: Taiwan Green Point Enterprises Co., Ltd., Taichung City (TW)

(72) Inventors: Sheng-Hung YI, Taichung City (TW); Pen-Yi LIAO, Taichung City (TW); Huai-Liang CHIEN, Taichung City (TW)

(73) Assignee: TAIWAN GREEN POINT ENTERPRISES CO., LTD., Taichung City (TW)

(21) Appl. No.: 14/636,454

(22) Filed: Mar. 3, 2015

(30) Foreign Application Priority Data
Mar. 4, 2014 (TW) 103107210

(51) Int. Cl. G06F 3/044

(52) U.S. Cl. CPC G06F 3/044; G06F 2203/04103

(57) ABSTRACT

A touch sensitive housing includes an insulator housing and conductive first and second touch sensor layers formed on the insulator housing, stacked one over the other and insulated from each other. At least one of the first and second touch sensor layers includes a patterned seed sub-layer including a catalytically active metal useful for activating electroless plating and a base sub-layer of a base metal formed on the seed sub-layer and having structural characteristics indicative of the base sub-layer being formed by electroless plating techniques.

### CROSS-REFERENCE TO RELATED APPLICATION

This application claims priority of Taiwanese Patent Application No. 103107210, filed on Mar. 4, 2014.

### FIELD

Embodiments of the invention generally relate to a touch sensitive housing and methods of making the same, more particularly to a touch sensitive housing including an insulator housing and first and second touch sensor layers formed on the insulator housing.

### BACKGROUND

U.S. Pat. No. 8,692,790 discloses a touch sensitive housing that includes a housing wall having an insulative surface and an array of capacitive touch sensor pads formed on the insulative surface for providing touch input functions to an electronic device. Each of the touch sensor pads has an active metal layer and an electroless deposited metal layer deposited on the active metal layer. The active metal layer is capable of catalytically initiating electroless deposition, and may be selected from the group consisting of palladium, rhodium, platinum, iridium, osmium, gold, nickel, iron, and combinations thereof.

There is still a need for further improving the touch function of the touch sensitive housing.

### SUMMARY

In certain embodiments of the disclosure, a touch sensitive housing may be provided. Such a touch sensitive housing may include an insulator housing and conductive first and second touch sensor layers formed on the insulator housing, stacked one over the other and insulated from each other. At least one of the first and second touch sensor layers includes a patterned seed sub-layer comprising a catalytically active metal useful for activating electroless plating and a base sub-layer of a base metal formed on the seed sub-layer and having structural characteristics indicative of the base sub-layer being formed by electroless plating techniques.

In certain embodiments of the disclosure, a method of making a touch sensitive housing may be provided. Such a method may include: providing inner and outer housing parts; forming a first touch sensor layer on the inner housing part; forming an insulator isolating layer on the first touch sensor layer to cover the first touch sensor layer; forming a second touch sensor layer on one of the outer housing part and the insulator isolating layer; and stacking the inner and outer housing parts one over the other to form an insulator housing, such that the first and second touch sensor layers are disposed between the inner and outer housing parts, and are separated from each other by the insulator isolating layer.

Such a method may include: forming first and second touch sensor layers on opposite outer and inner surfaces of an insulator housing, respectively, such that the first and second touch sensor layers cooperatively perform touch sensing actions; and forming an insulator isolating layer on the first touch sensor layer to cover the first touch sensor layer.

Such a method may include: forming patterned first and second seed sub-layers including a catalytically active metal on two opposite surfaces of a housing preform, respectively; bending and shaping the assembly of the housing preform and the first and second seed sub-layers to form a curved structure; and forming first and second base sub-layers of a base metal on the first and second seed sub-layers of the curved structure, respectively, by electroless plating techniques, such that the first and second base sub-layers cooperate with the first and second seed sub-layers to form first and second touch sensor layers, respectively.

### BRIEF DESCRIPTION OF THE DRAWINGS

Other features and advantages of the disclosure will become apparent in the following detailed description of the exemplary embodiments with reference to the accompanying drawings, of which:

FIGS. 1 to 4 are schematic views illustrating consecutive steps of certain embodiments of a method of making a touch sensitive housing according to the disclosure;

FIG. 5 is a schematic view of a configuration of first and second touch sensor layers of the touch sensitive housing of certain embodiments according to the disclosure;

FIG. 6 is a schematic view of another configuration of first and second touch sensor layers of the touch sensitive housing of certain embodiments according to the disclosure;

FIGS. 7A to 7E are schematic views illustrating consecutive steps of certain embodiments of a method of making a touch sensitive housing according to the disclosure;

FIGS. 8A to 8C are schematic views illustrating consecutive steps of certain embodiments of a method of making a touch sensitive housing according to the disclosure;

FIGS. 9A to 9C are schematic views illustrating consecutive steps of certain embodiments of a method of making a touch sensitive housing according to the disclosure;

FIGS. 10A and 10B are schematic views illustrating consecutive steps of certain embodiments of a method of making a touch sensitive housing according to the disclosure;

FIGS. 11 to 12 are schematic views illustrating consecutive steps of certain embodiments of a method of making a touch sensitive housing according to the disclosure; and

FIGS. 13A to 13E are schematic views illustrating consecutive steps of certain embodiments of a method of making a touch sensitive housing according to the disclosure.

### DETAILED DESCRIPTION

It may be noted that like elements are denoted by the same reference numerals throughout the disclosure.

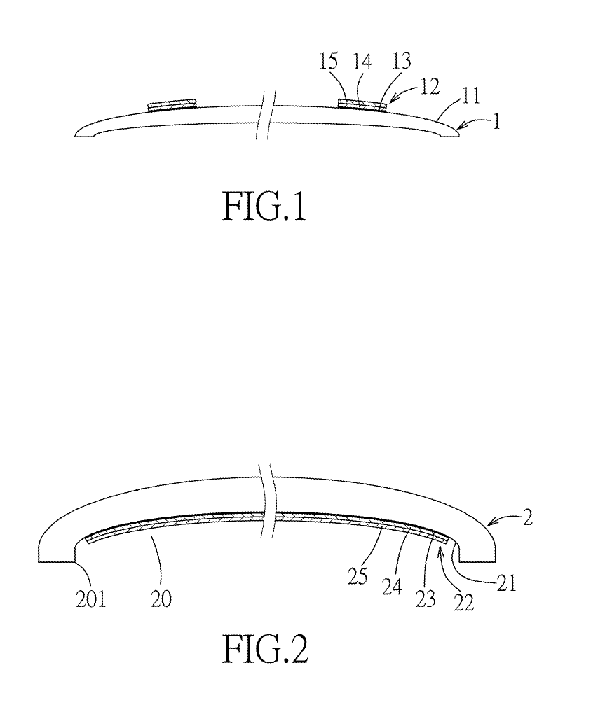

FIGS. 1 to 4 illustrate consecutive steps of certain embodiments of a method of making a touch sensitive housing of the disclosure. Such a method may include: providing inner and outer housing parts 1, 2 (see FIGS. 1 and 2); forming a first touch sensor layer 12 on a curved outer surface 11 of the inner housing part (see FIG. 1); forming a second touch sensor layer 22 on a curved inner surface 21 of the outer housing part 2 (see FIG. 2); forming an insulator isolating layer 10 on the first touch sensor layer 12 and the outer surface 11 of the inner housing part 1 to cover the first touch sensor layer 12 and the outer surface 11 of the inner housing part 1 (see FIG. 3); and stacking the inner and outer housing parts 1, 2 one over the other to form an insulator housing 300, such that the first and second touch sensor layers 12, 22 are disposed between the inner and outer housing parts 1, 2, are insulatively separated from each other by the insulator isolating layer 10 and are stacked one over the other. The first touch sensor layer 12 serves as a first electrode layer. The second touch sensor layer 22 serves as a second electrode layer, and is electrically and capacitively coupled to the first touch sensor layer 12 to perform touch sensing actions (see FIG. 4).

In certain embodiments, the outer housing part 2 may have a structure, such as the one shown in FIGS. 3 and 4, that embraces and is secured to the inner housing part 1. The structure of the outer housing part 2 is concave in shape, has a generally U-shaped cross-section, and defines a recess 20 and a recess opening 201. The inner housing part 1 is fitted into the recess 20, and covers the recess opening 201. The insulator isolating layer 10 may be disposed between and bonded to the inner and outer housing parts 1, 2, and may cooperate with the inner housing part 1 to enclose the first touch sensor layer 12.

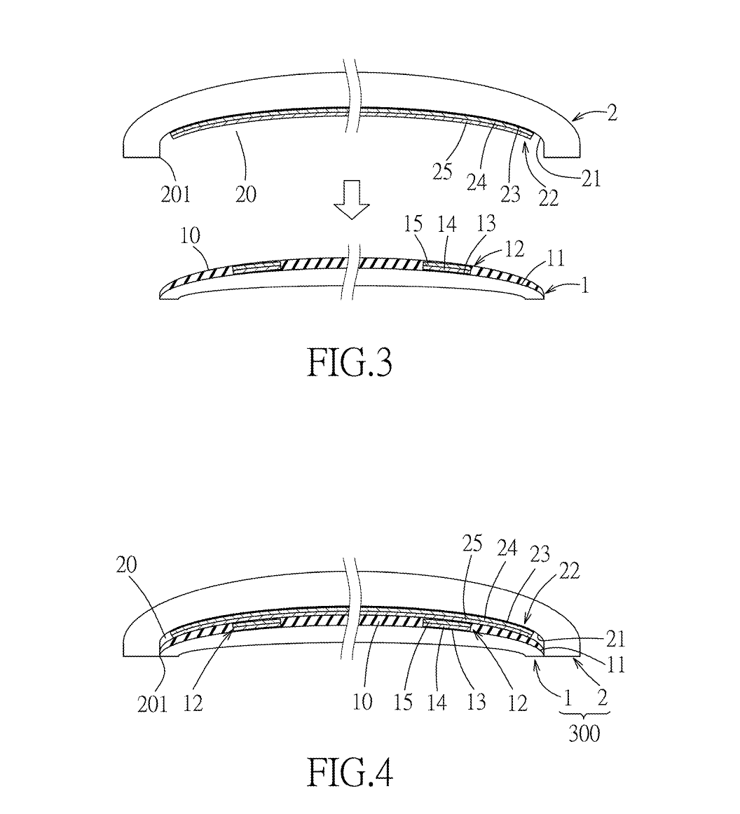

Referring to FIG. 5, in certain embodiments, the first touch sensor layer 12 may be patterned into a plurality of parallel first conductive lines 121 extending in a first direction (X), and the second touch sensor layer 22 may be patterned into a plurality of parallel second conductive lines 221 extending in a second direction (Y) that is perpendicular to the first direction (X). Each of the first conductive lines 121 crosses the second conductive lines 221.

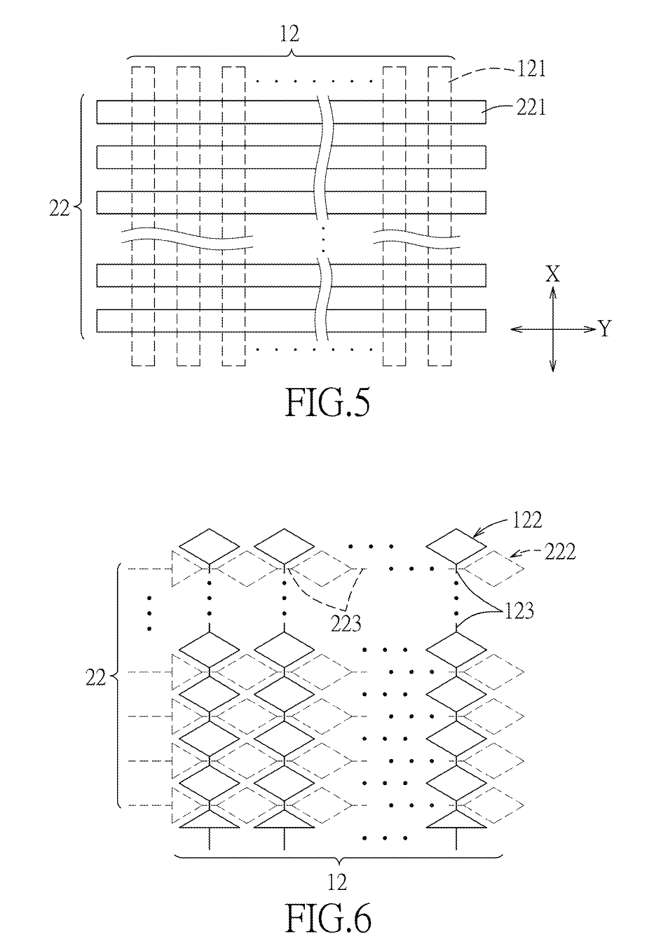

Referring to FIG. 6, in certain embodiments, the first touch sensor layer 12 may be patterned into an array of first conductive pads 122 and conductive first interconnecting lines 123, and the second touch sensor layer 22 may be patterned into an array of second conductive pads 222 and conductive second interconnecting lines 223. The first conductive pads 122 are interconnected through the first interconnecting lines 123. The second conductive pads are interconnected through the second interconnecting lines 223. The first and second conductive pads 122, 222 are arranged in a staggered manner.

Referring back to FIGS. 1 and 2, in certain embodiments, each of the first and second touch sensor layers 12, 22 may have a structure that includes a patterned seed sub-layer 13 of a catalytically active metal, a patterned base sub-layer 14 of a base metal formed on the seed sub-layer 13, and optionally a patterned top sub-layer 15 of a metal formed on the base sub-layer 14. The catalytically active metal is useful for activating electroless plating. The catalytically active metal may be selected from the group consisting of palladium, rhodium, platinum, iridium, osmium, gold, nickel, iron, and combinations thereof. The base metal may have structural characteristics indicative of the base sub-layer 14 being formed by electroless plating techniques. The base metal may be selected from the group consisting of nickel, silver, gold, and copper.

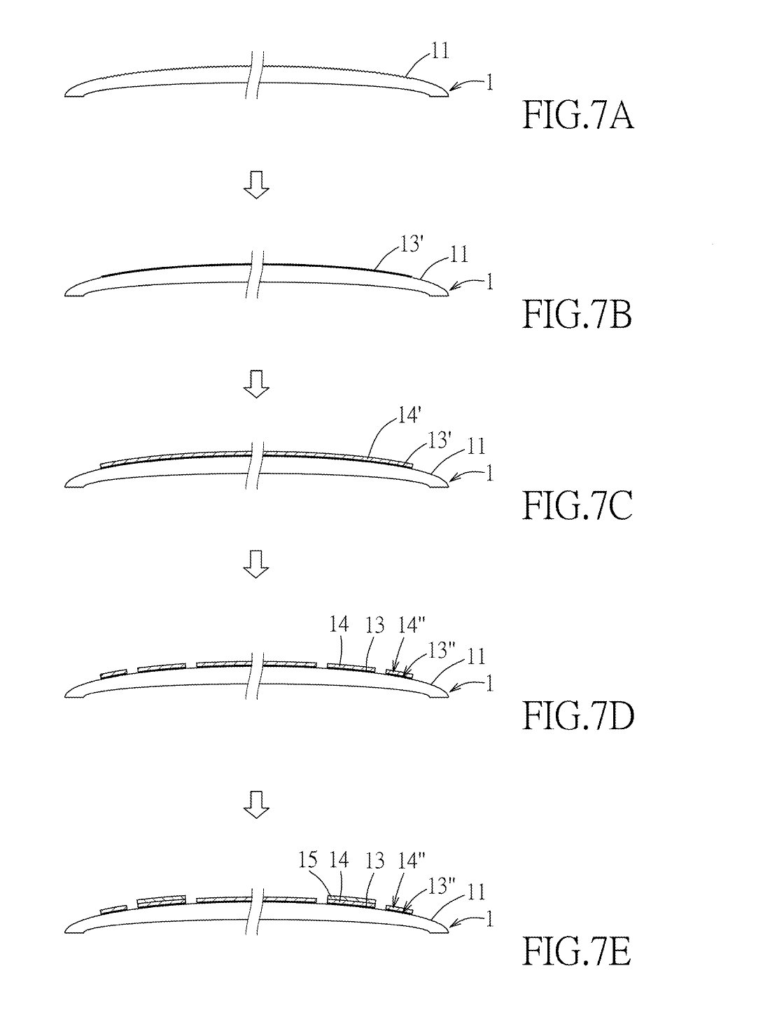

Referring to FIGS. 7A to 7E, in certain embodiments, the first touch sensor layer 12 may be formed on the inner housing part 1 by a process including: roughening the outer surface 11 of the inner housing part (see FIG. 7A); immersing the roughened inner housing part 1 in an active metal-containing solution so as to form a non-patterned seed sub-layer 13′ of the active metal on the roughened outer surface 11 of the inner housing part 1 (see FIG. 7B); electroless plating a non-patterned base sub-layer 14′ of the base metal on the non-patterned seed sub-layer 13′ (see FIG. 7C); patterning an assembly of the non-patterned base sub-layer 14′ and the non-patterned seed sub-layer 13′ using laser engraving techniques so as to form a patterned intermediate base sub-layer 14″ and a patterned intermediate seed sub-layer 13″ on the inner housing part (see FIG. 7D), the intermediate base sub-layer 14″ including a portion that defines the base sub-layer 14 (see FIG. 1), the intermediate seed sub-layer 13″ including a portion that defines the seed sub-layer 13 (see FIG. 1); electroplating the top sub-layer 15 on the base sub-layer 14 (see FIG. 7E); and removing the remaining portion of the intermediate base sub-layer 14″ and the remaining portion of the intermediate seed sub-layer 13″ so as to form the structure shown in FIG. 1. Since the assembly of the non-patterned base sub-layer 14′ and the non-patterned seed sub-layer 13′ is patterned using the laser engraving techniques, the patterned base sub-layer 14 and the patterned seed sub-layer 13 thus formed have structural characteristics indicative of the patterned base sub-layer 14 and the patterned seed sub-layer 13 being processed by laser engraving techniques.

In certain embodiments, the second touch sensor layer 22 may be formed on the inner surface 21 of the outer housing part 2 by a process similar to that of the first touch sensor layer 12.

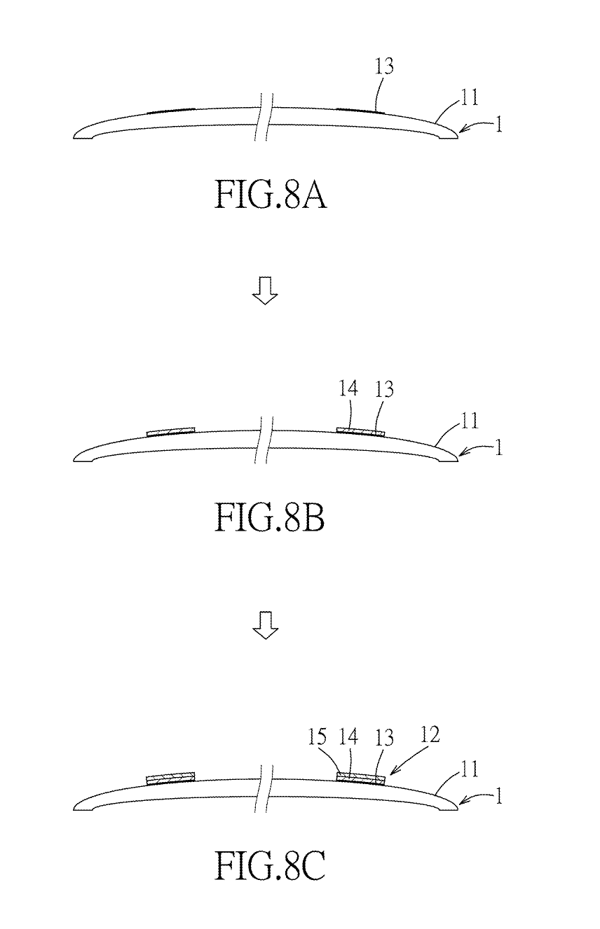

Referring to FIGS. 8A to 8C, in certain embodiments, the first touch sensor layer 12 may be formed on the outer surface 11 of the inner housing part 1 by a process including: forming a patterned seed sub-layer 13 of an ink material (which contains the active metal, an organic solvent and a binder) using screen printing (see FIG. 8A); electroless plating a patterned base sub-layer 14 of the base metal on the patterned seed sub-layer 13 (see FIG. 8B); and electroplating a patterned top sub-layer 15 of a metal on the patterned base sub-layer 14 using electroplating techniques (see FIG. 8C). In such embodiments, the second touch sensor layer 22 may be formed on the outer housing part 2 by a process similar to that of the first touch sensor layer 12.

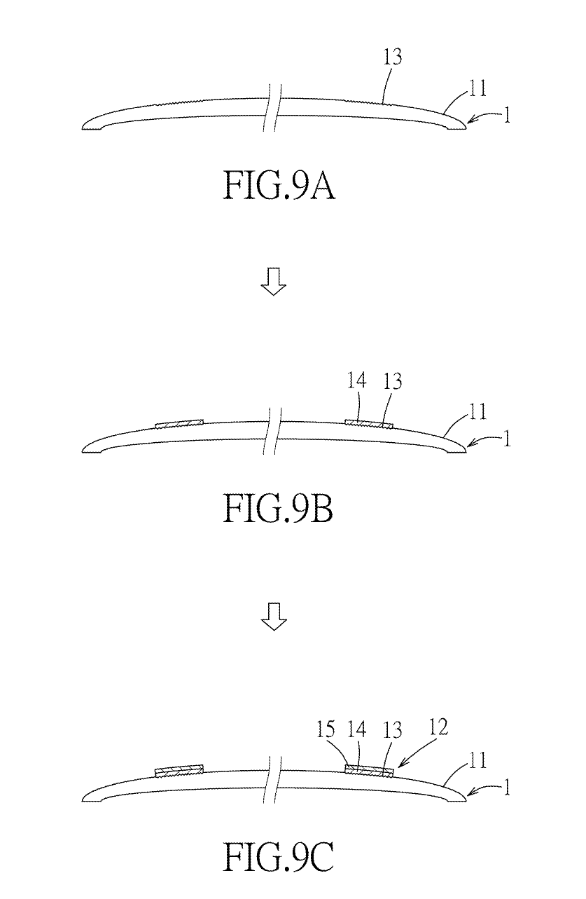

Referring to FIGS. 9A to 9C, in certain embodiments, the first touch sensor layer 12 may be formed on the outer surface 11 of the inner housing part 1 by a process including: providing the inner housing part 1 that is made from a material which may contain a resin matrix and the active metal dispersed in the resin matrix; laser ablating the outer surface 11 of the inner housing part 1, such that the outer surface 11 is formed with a patterned seed sub-layer 13 (i.e., ablated regions of the outer surface 11) of the active metal that are exposed from the surface (see FIG. 9A); electroless plating a patterned base sub-layer 14 of the base metal on the patterned seed sub-layer 13 (see FIG. 9B); and electroplating a patterned top sub-layer 15 of a metal on the patterned base sub-layer 14 using electroplating techniques (see FIG. 9C). In such embodiments, the second touch sensor layer 22 may be formed on the outer housing part 2 by a process similar to that of the first touch sensor layer 12.

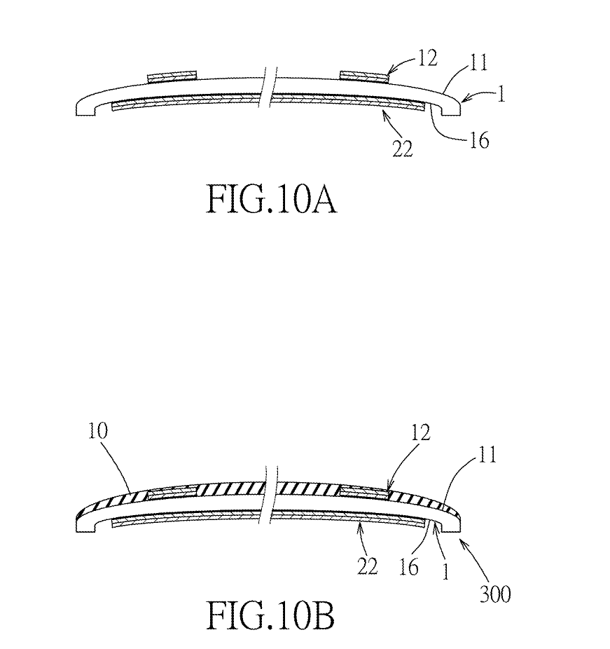

Referring to FIG. 10B, in certain embodiments, the touch sensitive housing may have a structure that is dispensed with the outer housing part 2 as compared to those embodiments shown in FIG. 4, i.e., the insulator housing 300 is solely defined by the inner housing part 1. In such embodiments, referring to FIG. 10A, the first and second touch sensor layers 12, 22 are firstly formed on opposite outer and inner surfaces 11, 16 of the insulator housing 300 defined by the inner housing part 1, respectively. The insulator isolating layer 10 is then formed on the insulator housing 300 to cover the first touch sensor layer 12 and the outer surface 11 of the insulator housing 300 (see FIG. 10B), and cooperates with the outer surface 11 of the insulator housing 300 to enclose the first touch sensor layer 12.

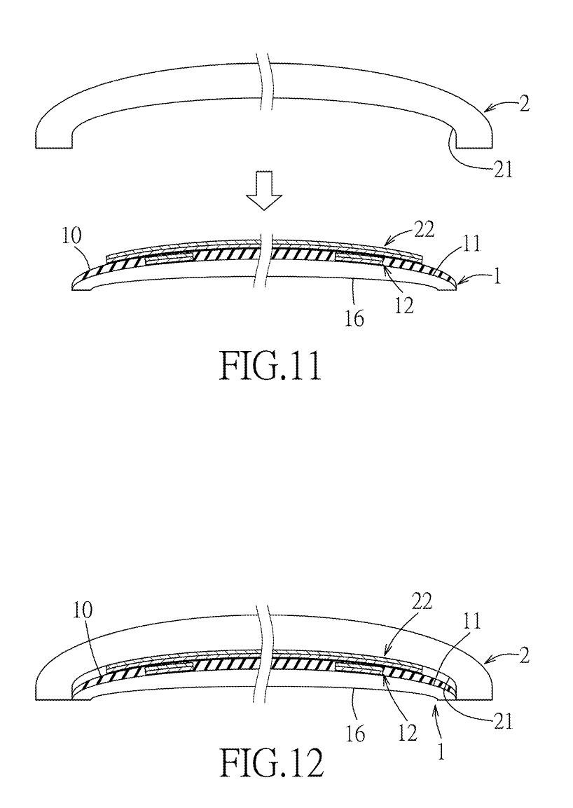

Referring to FIGS. 11 and 12, in certain embodiments, the second touch sensor layer 22 may be formed on the insulator isolating layer 10 (see FIG. 11) instead of forming on the inner surface 21 of the outer housing part 2 as compared to those embodiments shown in FIGS. 1 to 4, followed by attaching the outer housing part 2 to an assembly of the inner housing part 1, the first and second touch sensor layers 12, 22 and the insulator isolating layer 10 (see FIG. 12).

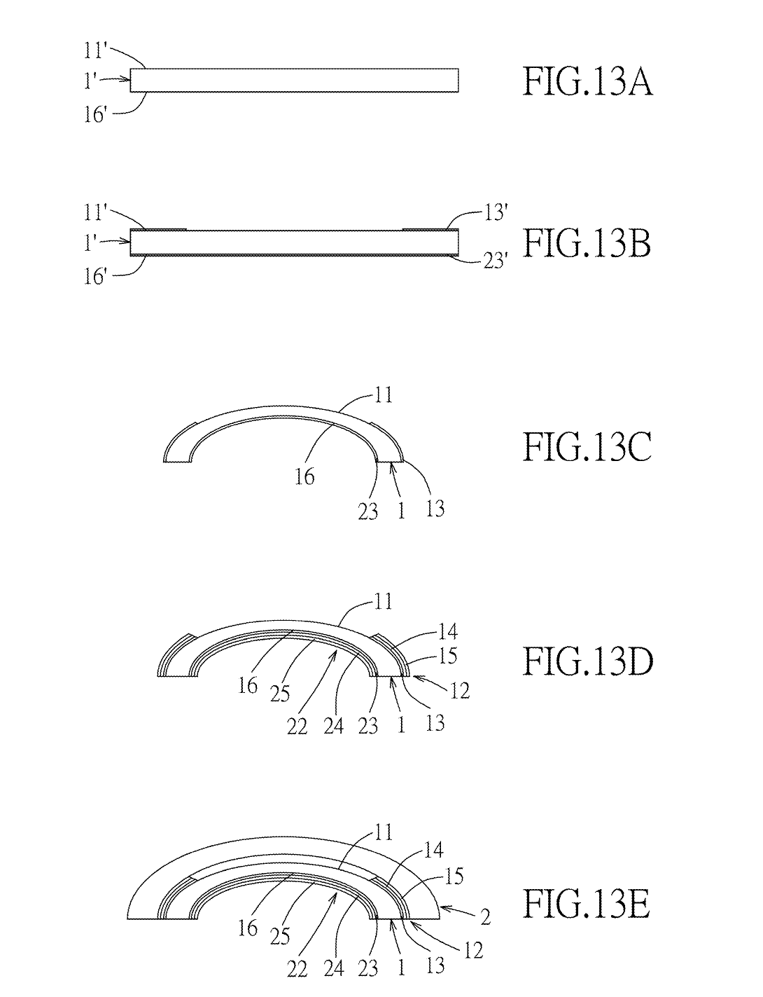

Referring to FIG. 13E, in certain embodiments, the touch sensitive housing may have a structure that is dispensed with the insulator isolating layer 10 as compared to those embodiments shown in FIG. 4. In such embodiments, the first and second touch sensor layers 12, 22 are respectively formed on outer and inner surfaces 11, 16 of the inner housing part 1. The assembly of the inner housing part 1 and the patterned seed sub-layers 13, 23 of the first and second touch sensor layers 12, 22 is bent and shaped into a curved structure, and has structural characteristics indicative of the assembly of the inner housing part 1 and the patterned seed sub-layers 13, 23 of the first and second touch sensor layers 12, 22 being bent and shaped. The outer housing part 2 is molded over the first touch sensor layer 12 and the outer surface 11 of the inner housing part 1.

FIGS. 13A to 13E illustrate consecutive steps of a method of making the touch sensitive housing of these embodiments. The method includes: providing a housing preform 1′ (see FIG. 13A); forming patterned first and second intermediate seed sub-layers 13′, 23′ of a catalytically active metal on outer and inner surfaces 11′, 16′ of the housing preform 1′, respectively, by printing an ink material (which contains the active metal, an organic solvent and a binder) on the outer and inner surfaces 11′, 16′ of the housing preform 1′ using screen printing techniques (see FIG. 13B); bending and shaping the assembly of the housing preform 1′ and the patterned first and second intermediate seed sub-layers 13′, 23′ to form a curved structure (see FIG. 13C), the bent housing preform 1′ defining the inner housing part 1 with the outer and inner surfaces 11, 16, the bent first and second intermediate seed sub-layers 13′, 23′ defining the first and second seed sub-layers 13, 23, respectively; forming patterned first and second base sub-layers 14, 24 of the base metal on the first and second seed sub-layers 13, 23 of the curved structure, respectively, using electroless plating techniques (see FIG. 13D); electroplating patterned top sub-layers 15, 25 of a metal on the patterned first and second base sub-layers 14, 24, respectively, such that the patterned first and second top sub-layers 15, 25 cooperate with the patterned first and second base sub-layers 14, 24 and the first and second seed sub-layers 13, 23 to form first and second touch sensor layers 12, 22, respectively (see FIG. 13D); and forming the outer housing part 2 on the first touch sensor layer 12 (see FIG. 13E) and the outer surface 11 of the inner housing part 1 using injection molding techniques.

In certain embodiments, the inclusion of the first and second touch sensor layers 12, 22 in the touch sensitive housing of the disclosure may be advantageous over the aforesaid conventional touch sensitive housing in increasing the touch sensing resolution and broadening the application of the touch sensitive housing.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A touch sensitive housing comprising:
an insulator housing; and
conductive first and second touch sensor layers formed on said insulator housing, stacked one over the other and insulated from each other;
wherein at least one of said first and second touch sensor layers includes a patterned seed sub-layer comprising a catalytically active metal useful for activating electroless plating and a patterned base sub-layer of a base metal formed on said patterned seed sub-layer and having structural characteristics indicative of said patterned base sub-layer being formed by electroless plating techniques.

2. The touch sensitive housing as claimed in claim 1, wherein said insulator housing includes inner housing part and an outer housing part embracing and secured to said inner housing part, at least one of said first and second touch sensor layers being disposed between said inner and outer housing parts.

3. The touch sensitive housing as claimed in claim 2, wherein said first touch sensor layer is disposed between said first and second housing parts and is formed on said first housing part, said insulator housing further including an insulator isolating layer disposed between and bonded to said inner and outer housing parts and cooperating with said inner housing part to enclose said first touch sensor layer.

4. The touch sensitive housing as claimed in claim 3, wherein said second touch sensor layer is formed on said outer housing part, is disposed between said inner and outer housing parts, and is separated from said first touch sensor layer by said insulator isolating layer.

5. The touch sensitive housing as claimed in claim 3, wherein said second touch sensor layer is formed on said insulator isolating layer, is disposed between said inner and outer housing parts, and is separated from said first touch sensor layer by said insulator isolating layer.

6. The touch sensitive housing as claimed in claim 1, further comprising an insulator isolating layer formed on said insulator housing, said insulator housing having outer and inner surfaces, said first and second touch sensor layers being respectively formed on said outer and inner surfaces, said insulator isolating layer cooperating with said outer surface of said insulator housing to enclose said first touch sensor layer.

7. The touch sensitive housing as claimed in claim 1, wherein said patterned seed sub-layer has structural characteristics indicative of said patterned seed sub-layer being processed by laser engraving techniques.

8. The touch sensitive housing as claimed in claim 2, wherein said inner housing part has outer and inner surfaces, said first and second touch sensor layers being respectively formed on said outer and inner surfaces, said first touch sensor layer being disposed between said outer and inner housing parts, each of said first and second touch sensor layers including said patterned seed sub-layer and said patterned base sub-layer, the assembly of said inner housing part and said patterned seed sub-layers of said first and second touch sensor layers being bent and shaped into a curved structure and having structural characteristics indicative of the assembly of said inner housing part and said patterned seed sub-layers of said first and second touch sensor layers being bent and shaped.

9. The touch sensitive housing as claimed in claim 8, wherein said outer housing part is molded over said first touch sensor layer and said outer surface of said inner housing part.

10. The touch sensitive housing as claimed in claim 1, wherein said insulator housing is made from a material comprising a resin matrix and an active metal dispersed in the resin matrix.

11. A method of making a touch sensitive housing, comprising:
providing inner and outer housing parts;
forming a first touch sensor layer on the inner housing part;
forming an insulator isolating layer on the first touch sensor layer to cover the first touch sensor layer;
forming a second touch sensor layer on one of the outer housing part and the insulator isolating layer; and
stacking the inner and outer housing parts one over the other to form an insulator housing, such that the first and second touch sensor layers are disposed between the inner and outer housing parts, and are separated from each other by the insulator isolating layer.

12. The method as claimed in claim 11, wherein the first touch sensor layer is formed on the inner housing part by forming a patterned seed sub-layer comprising a catalytically active metal on the inner housing part and a patterned base sub-layer of a base metal on the patterned seed sub-layer.

13. The method as claimed in claim 12, wherein the patterned seed sub-layer is formed by forming a non-patterned seed sub-layer on the inner housing part, the patterned base sub-layer being formed through electroless plating and laser engraving.

14. The method as claimed in claim 12, wherein the inner housing part is made from a material comprising a resin matrix, the patterned seed sub-layer being formed by laser ablating the outer surface of the inner housing part such that the outer surface is formed with the patterned seed sub-layer.

15. A method of making a touch sensitive housing, comprising:
forming first and second touch sensor layers on opposite outer and inner surfaces of an insulator housing, respectively, such that the first and second touch sensor layers cooperatively perform touch sensing actions; and
forming an insulator isolating layer on the first touch sensor layer to cover the first touch sensor layer.

16. The method as claimed in claim 15, wherein the first touch sensor layer is formed on the insulator housing by forming a patterned seed sub-layer comprising a catalytically active metal on the insulator housing and a patterned base sub-layer of a base metal on the patterned seed sub-layer.

17. The method as claimed in claim 16, wherein the patterned seed sub-layer is formed by forming a non-patterned seed sub-layer on the inner housing part, the patterned base sub-layer being formed through electroless plating and laser engraving.

18. A method of making a touch sensitive housing, comprising:
forming patterned first and second seed sub-layers comprising a catalytically active metal on two opposite surfaces of a housing preform, respectively;
bending and shaping the assembly of the housing preform and the patterned first and second seed sub-layers to form a curved structure; and
forming patterned first and second base sub-layers of a base metal on the patterned first and second seed sub-layers of the curved structure, respectively, using electroless plating techniques, such that the patterned first and second base sub-layers cooperate with the patterned first and second seed sub-layers to form first and second touch sensor layers, respectively.

19. The method as claimed in claim 18, further comprising forming an outer housing part, the housing preform being formed into an inner housing part after the bending and shaping of the housing preform, the outer housing part being molded over the first touch sensor layer and the inner housing part.

20. The method as claimed in claim 18, wherein the first and second touch sensor layers are electrically coupled to each other to perform touch sensing actions.
